(19) United States
(12) Patent Application Publication
(10) Pub. No.: US 2004/0207869 A1
(43) Pub. Date: Oct. 21, 2004

(54) Image data transmitting device, and image data transmitting and receiving system

(75) Inventor: Masakatsu Endo, Nagano-Ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/637,720

(22) Filed: Aug. 11, 2003

(30) Foreign Application Priority Data
Aug. 9, 2002 (JP) 2002-232855

(51) Int. Cl. G06F 15/00; H04N 1/21

(52) U.S. Cl. 358/1.15; 358/302

(57) ABSTRACT

When a user presses a menu button, a digital camera displays a menu screen to perform setting when image data held in the digital camera is transmitted to an image data receiving device such as a printer, a projector, or a backup storage. In the display of the menu screen, the digital camera selects and changes menu contents according to the kind of an image data receiving device to which the digital camera is connected. Consequently, user-friendliness regarding setting when the image data in the digital camera is transmitted to the image data receiving device increases.

### BACKGROUND OF THE INVENTION

1. Field of the Invention

The present invention relates to an image data transmitting device, and an image data transmitting and receiving system, and particularly relates to an image data transmitting device, and an image data transmitting and receiving system, in which an image data receiving device processes image data transmitted from the image data transmitting device to the image data receiving device based on setting made by the image data transmitting device.

2. Description of the Related Art

The digital camera exists as a device which is connected to a printer for printing. Namely, it is possible to directly connect the digital camera to the printer by a USB (Universal Serial Bus) communication interface cable or the like and print an image taken by the digital camera with the printer. In this case, not only image data but also print setting for printing based on the image data is transmitted from the digital camera to the printer.

It is also possible to connect the digital camera to a projector and project the image taken by the digital camera on a projector screen. In this case, not only the image data but also projector setting for projection based on the image data is transmitted from the digital camera to the projector.

It is also possible to connect the digital camera to a backup mass storage and store the image taken by the digital camera in the mass storage. In this case, not only the image data but also storage setting for storing the image data is transmitted from the digital camera to the mass storage.

As stated above, there are various kinds of image data receiving devices to which the digital camera is connected via the USB communication interface cable or the like, and in some cases, items set on the digital camera side and kinds of options thereof differ according to the kind of the image data receiving device. However, in conventional digital cameras, the display and contents of a setting screen of the digital camera are the same regardless of the kind of the image data receiving device as a partner to which the image data is transmitted. However, it is convenient for users if the setting screen can be changed properly according to the partner to which the digital camera is connected.

Moreover, since digital cameras are sold in various regions, there is a possibility that various languages are used. Hence, it is convenient if the setting screen of the digital camera can be changed automatically according to the language of a nation or a region where the digital camera and the image data receiving device are used.

The aforementioned problems are not limited to the digital camera, and arise similarly in any image data transmitting device which transmits image data to an image data receiving device.

### SUMMARY OF THE INVENTION

Hence, the present invention is made in view of the aforementioned problems, and an object of the present invention is to increase user-friendliness by changing a setting display of an image data transmitting device automatically according to an image data receiving device to which the image data transmitting device is connected.

In order to accomplish the aforementioned and other objects, according to one aspect of the present invention, a control method of an image data transmitting device connected to an image data receiving device, comprises the steps of:

acquiring device information on the image data receiving device from the image data receiving device to which the image data transmitting device is connected;

selecting contents of setting on image data of the image data receiving device when the image data is transmitted to the image data receiving device based on the acquired device information; and

displaying the selected contents of setting.

According to another aspect of the present invention, an image data transmitting device connected to an image data receiving device, comprises:

a device information acquisition which acquires device information on the image data receiving device from the image data receiving device to which the image data transmitting device is connected;

a setting displayer which displays setting on image data of the image data receiving device when the image data is transmitted to the image data receiving device; and

a display selector which selects contents of the setting displayed on the setting displayer based on the device information acquired by the device information acquisition.

According to another aspect of the present invention, an image data transmitting and receiving system includes an image data receiving device and an image data transmitting device connected to the image data receiving device, wherein the image data transmitting device comprises:

a device information acquisition which acquires device information on the image data receiving device from the image data receiving device to which the image data transmitting device is connected;

a setting displayer which displays setting on image data of the imaged at a receiving device when the image data is transmitted to the image data receiving device;

a display selector which selects contents of the setting displayed on the setting displayer based on the device information acquired by the device information acquisition; and

a transmitter which transmits setting information set by a user based on the display selector and the image data to the image data receiving device, and

the image data receiving device comprises:

a receiver which receives the setting information and the image data; and

an image data processor which processes the image data based on the setting information.

### BRIEF DESCRIPTION OF THE DRAWINGS

FIG. 1 is a block diagram explaining the configuration of a print system according to an embodiment of the present invention;

FIG. 2 is a diagram explaining the configuration of logical pipes formed between a digital camera and a printer in this embodiment;

FIG. 3 is a sequence diagram showing an example of an initial communication procedure immediately after communication has been established between the digital camera and the printer according to this embodiment;

FIG. 4 is a sequence diagram showing an example of a communication procedure between the digital camera and the printer when a print request is transmitted from the digital camera to the printer according to this embodiment;

FIG. 5 is a diagram showing an example of a format of a printer protocol confirmation command transmitted from the printer to the digital camera according to this embodiment;

FIG. 6 is a diagram showing a list of information stored in product information of the printer protocol confirmation command according to this embodiment;

FIG. 7 is a diagram showing a list of information stored in region information of the printer protocol confirmation command according to this embodiment;

FIG. 8 is a diagram explaining an example of the configuration of print setting data stored in a memory of the digital camera according to this embodiment;

FIG. 9 is a diagram explaining a list of setting items each including an option which depends on printer setting out of setting items of print setting data and options thereof;

FIG. 10 is a diagram explaining a layout on the operation surface side of the digital camera according to this embodiment;

FIG. 11 is a diagram showing an example of a Japanese print menu displayed on a liquid crystal display panel of the digital camera according to this embodiment;

FIG. 12 is a flowchart explaining the contents of a paper size addition process executed by a camera controller of the digital camera according to this embodiment;

FIG. 13 is a flowchart explaining the contents of a menu display process executed by the camera controller of the digital camera according to this embodiment;

FIG. 14 is a diagram showing an example of an English print menu displayed on the liquid crystal display panel of the digital camera according to this embodiment;

FIG. 15 is a diagram showing an example of a Japanese display menu displayed on the liquid crystal display panel of the digital camera according to this embodiment;

FIG. 16 is a diagram showing an example of an English display menu displayed on the liquid crystal display panel of the digital camera according to this embodiment;

FIG. 17 is a diagram showing an example of a Japanese backup menu displayed on the liquid crystal display panel of the digital camera according to this embodiment; and

FIG. 18 is a diagram showing an example of an English backup menu displayed on the liquid crystal display panel of the digital camera according to this embodiment.

### DETAILED DESCRIPTION OF THE EMBODIMENTS

In an embodiment of the present invention, a digital camera acquires vendor information on a printer, and based on this vendor information, it is determined whether roll paper is added to options in print setting made in the digital camera. Further, in this embodiment, the digital camera acquires product information on the printer, and based on this product information, the contents of a setting screen displayed on the digital camera are changed. Furthermore, in this embodiment, the digital camera acquires region information on the printer, and based on this region information, the language of the setting screen displayed on the digital camera is changed. Further details will be given below.

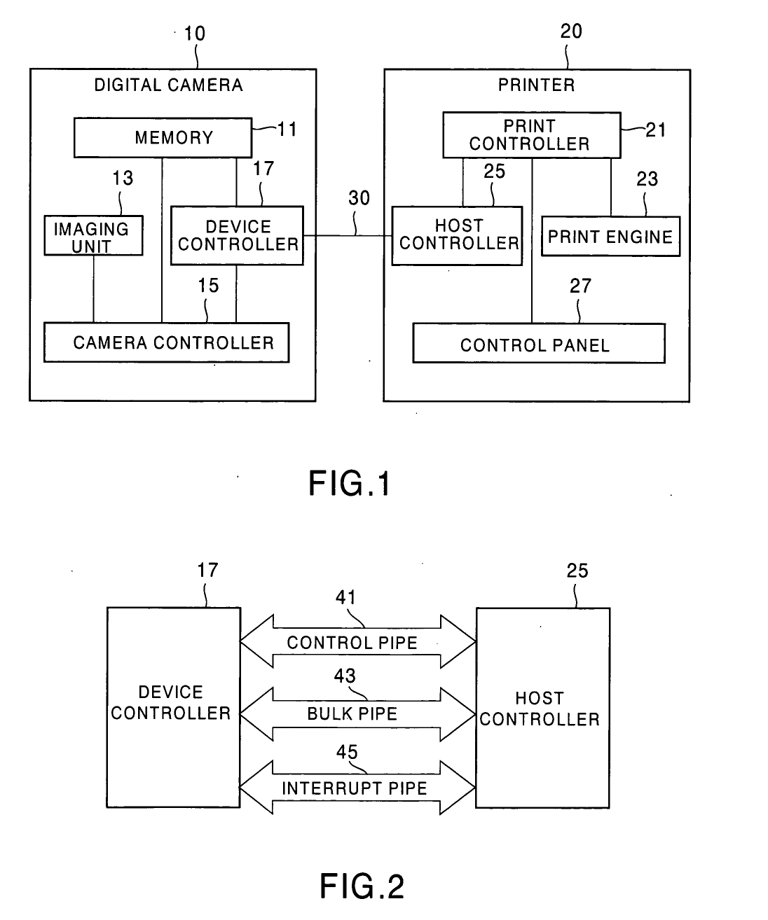

FIG. 1 is a block diagram explaining the entire configuration of a print system according to this embodiment. As shown in FIG. 1, the print system according to this embodiment includes a digital camera 10 and a printer 20 connected to the digital camera 10 via a USB communication interface cable 30.

The digital camera 10 includes a memory 11, an imaging unit 13, a camera controller 15, and a device controller 17. Image data taken by the imaging unit 13 is stored in the memory 11. This image data is stored, for example, in the form of a JPEG file or some other general format file. The imaging unit 13 takes a picture and converts it into an electrical signal.

Roughly speaking, the camera controller 15 controls operations of respective portions of the digital camera 10. The device controller 17 controls communication with a USB host such as the printer 20.

To be precise, the camera controller 15 includes various kinds of operation buttons including a shutter button, a liquid crystal display panel, and so on. According to a shutter button operation, the camera controller 15 drives the imaging unit 13 and allows the imaging unit 13 to take a picture, receives an electrical signal of a taken image from the imaging unit 13, creates a file of image data, and writes the file into the memory 11, or based on a predetermined image reference button operation, reads a desired image from the memory 11 and displays the image on the liquid crystal display panel.

Moreover, the camera controller 15 creates a control command (printer status request) which requests acquisition of a printer status regularly, selects and reads a file of image data to be printed from the memory 11 based on a user's image selection button operation, generates print setting data indicating the contents of print setting (for example, the number of copies to be printed, kind of paper, paper size, layout, date print, print quality, automatic correction, and the like) based on a user's print setting button operation, creates a control command (print request) which requests print execution based on a user's print request button operation following the image selection button operation, or creates a control command (print stop request) which requests a print stop based on a user's print stop button operation.

The device controller 17 has a function of communicating with the USB host while meeting the USB standard as a USB storage class device. Hence, the USB host can search various directories in the memory 11 and freely access a desired data file.

Further, although details will be given later, the device controller 17 according to this embodiment can transmit the aforementioned control commands such as the printer status request, print request, and print stop request created by the camera controller 15 to the printer 20 in virtually the same manner that the digital camera 10 voluntarily transmits the control commands.

Meanwhile, the printer 20 includes a print controller 21, a print engine 23, a host controller 25, and a control panel 27. Roughly speaking, the print controller 21 performs the transmission of the printer status, reading of an image file to be printed from the memory 11, rendering of a print image, and other various controls in response to the printer status request, print request, print stop request, and so on transmitted from the digital camera 10. The host controller 25 has a function of communicating with the USB device as the USB host. The print engine 23 executes a print operation under the control of the print controller 21.

To be precise, the print controller 21 includes a function of receiving general compression format image data such as a JPEG file or some other general format file, expanding the image data, and converting it into bitmap image data, a color conversion function of converting an RGB pixel value of the bitmap image datain to a CMYK pixel value, and a halftoning function of converting the multiple-tone pixel value of the color-converted bitmap image data into an area coverage modulation pixel value in which dots and blanks are represented.

Therefore, the digital camera 10 need not necessarily include a function of expanding, color-converting, and halftoning the image data file to be printed such as a JPEG file stored in the memory 11, and is only required to include a function of transmitting the image data file as it is to the printer 20. Consequently, the advantage that the configuration of the digital camera 10 need not be customized to each model of the printer 20 and may be for general purpose use can be obtained.

The host controller 25 has a function of reading and writing a desired data file in a desired directory by accessing the memory 11 of the digital camera 10, which functions as a storage class USB device, in accordance with the USB standard. Although details will be described later, the host controller 25 can receive the aforementioned control commands such as the printer status request, print request, and print stop request created by the camera controller 15 from the digital camera 10 in virtually the same manner that the control commands are transmitted voluntarily from the digital camera 10.

The control panel 27 is a panel operated when the user performs print setting and registers it with the printer 20. Namely, when the user performs print setting composed of setting items such as the number of copies to be printed, kind of paper, paper size, layout, date print, print quality, automatic correction, and the like and registers the print setting with the printer 20, the user performs necessary setting and registration by operating the control panel 27.

FIG. 2 is a diagram showing logical pipes (logical communication channels) used when the device controller 17 of the digital camera 10 and the host controller 25 of the printer 20 communicate with each other.

As shown in FIG. 2, three kinds of communication pipes of a control pipe 41, a bulk pipe 43, and an interrupt pipe 45 are used between the device controller 17 and the host controller 25. The control pipe 41 is used for the transmission of various kinds of control commands from the digital camera 10 to the printer 20 and from the printer 20 to the digital camera 10. The bulk pipe 43 is used for data transmission including the transmission of the image data file from the digital camera 10 to the printer 20 and the transmission of the printer status data from the printer 20 to the digital camera 10. The interrupt pipe 45 is used for the transmission of a request inquiry command of “Interrupt In” from the printer 20 to the digital camera 10.

All of these three kinds of pipes are defined by the USB standard. However, the USB standard prescribes nothing about the use of the interrupt pipe 45 in regard to communication by the storage device. Hence, in this embodiment, by effectively using the interrupt pipe 45, various kinds of control commands can be transmitted practically voluntarily from the USB storage type digital camera 10 to the USB host printer 20.

Namely, when the printer 20 is connected with the digital camera 10 via the USB communication interface cable 30, the printer 20 transmits the “Interrupt In” command to the digital camera 10 through the interrupt pipe 45 at very short intervals from the user's standpoint, for example, at least once per millisecond. Each time the digital camera 10 receives the “Interrupt In” command, the digital camera 10 transmits a reply thereto to the printer 20 through the control pipe 41.

When some kind of control command such as the aforementioned printer status request, print request, or print stop request was created in the digital camera 10 at a point in time when the digital camera 10 has received the “Interrupt In” command, the digital camera 10 transmits the control command as a reply to the “Interrupt In” command to the printer 20.

The printer 20 interprets the transmitted control command and executes the operation (for example, the transmission of the printer status, execution of a print operation, or stop of the print operation) requested by the digital camera 10. As a result, it becomes possible to operate the printer 20 seemingly under the practically voluntary control of the digital camera 10.

Incidentally, when executing the print operation in response to the print request, the printer 20 reads various data resources (for example, the image data file to be printed, the print setting data file, and soon) necessary for the print operation from the digital camera 10 at its own discretion by using the fact that the digital camera 10 is a storage class. Therefore, the digital camera 10 has only to perform the operation as the storage class of storing the data resources necessary for the print operation and reading the data resource in response to a read request from the printer 20.

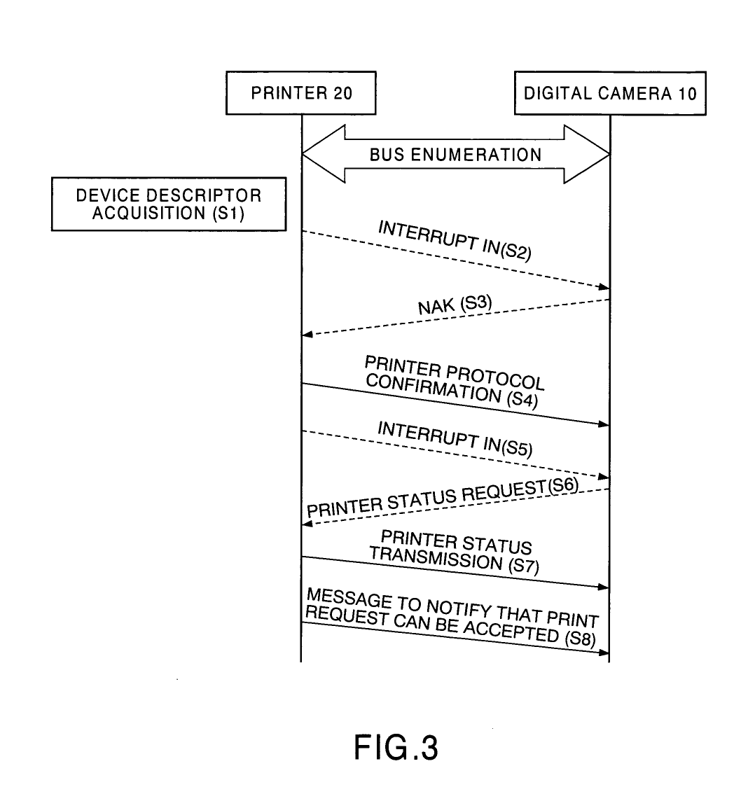

Next, the flow of initial communication performed at the early stages after a communication connection by USB has been established between the printer 20 and the digital camera 10 will be explained based on FIG. 3. As shown in FIG. 3, when both the printer 20 and the digital camera 10 are connected by the USB communication interface cable 30 while both of them are already powered on, or when both the printer 20 and the digital camera 10 are powered on while both of them are already connected by the USB communication interface cable 30, a USB communication connection is established between the printer 20 and the digital camera 10.

When the USB communication has been established, the host controller 25 of the printer 20 acquires from the device controller 17 of the digital camera 10 a “device descriptor” in which the configuration thereof as the USB device is described (step S1). The device descriptor from the digital camera 10 contains an “interface descriptor” in which it is described that the digital camera 10 is a storage class device. The interface descriptor contains a “string descriptor” in which plural end points of the USB used by the digital camera 10 (end points where packets are transmitted or received by using any of three kinds of pipes 41, 43, and 45 shown in FIG. 2) are enumerated.

Specifically, in this string descriptor, in addition to end points which are to be possessed by a storage device defined by the USB standard (for example, a “Bulk Out” end point and a “Bulk In” end point), an “Interrupt In” end point which is an additional end point in this embodiment is described. Accordingly, the host controller 25 of the printer 20 confirms that the digital camera 10 is a storage class device and a device which uses the “Interrupt In” command (command to inquire about a request on the USB device side).

The printer 20 which has acquired the device descriptor of the digital camera 10 transmits a “print protocol confirmation command” to the digital camera 10 through the control pipe 41 within a predetermined short time (for example, within one second) from this point in time (step S4). Thereby, the printer 20 notifies the digital camera 10 of the type of a used communication protocol (namely, the type which uses the “Interrupt In” command), the protocol version, and the like.

Aside from the above, after the communication connection has been established, the printer 20 transmits the “Interrupt In” command to the digital camera 10 through the interrupt pipe 45 periodically, for example, once per millisecond (step S2, Step S5, and so on). Each time the digital camera 10 receives the “Interrupt In” command, the digital camera 10 determines whether some control command is generated within the digital camera 10 at that point in time. If no control command is generated, the digital camera 10 transmits a “Nak” message”, which means no request, to the printer 20 through the control pipe 41 (step S3 and so on). On the other hand, when some control command is generated within the digital camera 10 at a point in time when the “Interrupt In” command has been received, the digital camera 10 transmits this control command to the printer 20 through the control pipe 41 (step S6 and so on).

As described above, such a control command is the printer status request, the print request, the print stop request, or the like. For example, in step S6 in FIG. 3, the printer status request is transmitted to the printer 20 as a reply to the “Interrupt In” command in step S5. The printer 20 which has received the printer status request checks up on the latest printer status and writes data indicating the printer status into a predetermined directory in the memory 11 of the digital camera 10 through the bulk pipe 43 (step S7). Thereby, the digital camera 10 acquires the latest printer status. Hence, for example, this printer status can be displayed on the liquid crystal display panel or the like of the digital camera 10.

Also, when the printer 20 is brought into a state capable of accepting the print request after the communication connection has been established, at the first reception of the printer status request in the state (step S6), the printer 20 not only transmits the printer status data to the digital camera 10 (step S7) but also transmits a message to notify that the print request can be accepted to the digital camera 10 through the control pipe 41 (step S8).

Incidentally, the timing in which the printer status request is generated in the digital camera 10 can be changed depending on the design of the digital camera 10, and the timing can be set at regular intervals, for example, at five-second intervals or at one-second intervals, for example, during the period from the transmission of the print request to the printer 20 till printing is completed, or during the period from the transmission of the print stop request to the printer 20 till printing is stopped.

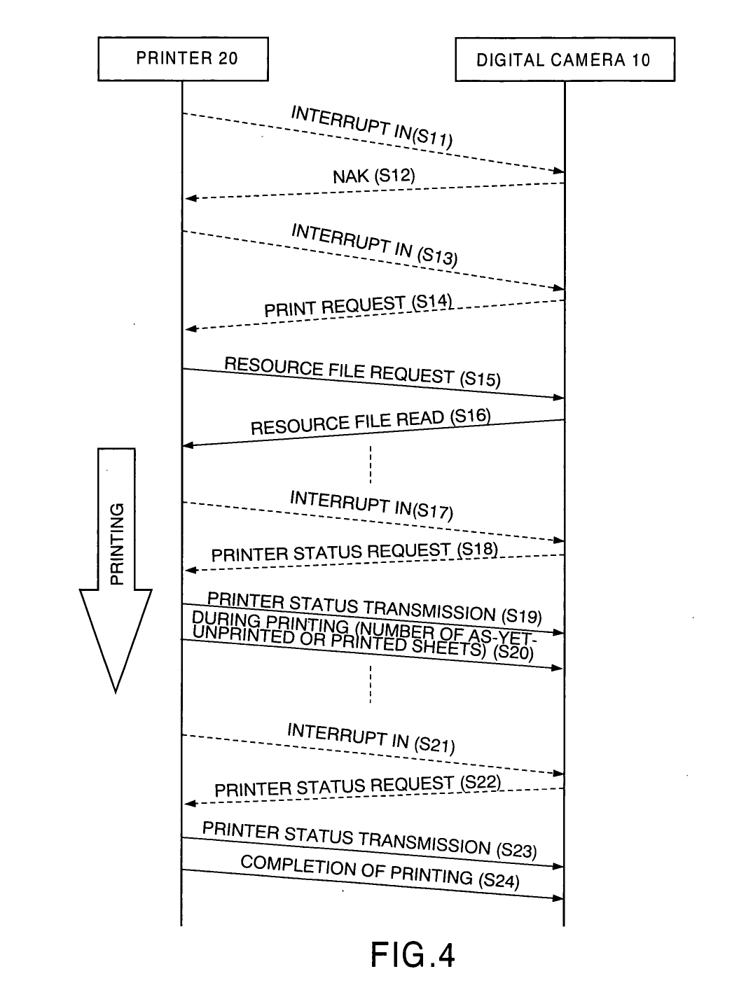

FIG. 4 shows an example of a communication procedure when the print request is transmitted from the digital camera 10 to the printer 20 and the printer 20 executes a print operation. As shown in FIG. 4, the printer 20 transmits the “Interrupt In” command to the digital camera 10 at predetermined time intervals (step S11, step S13, step S17, step S21, and so on). As shown in step S13, when the print request is generated in the digital camera 10 at a point in time when the “Interrupt In” command has been received, the digital camera 10 transmits the print request as a reply to the “Interrupt In” command to the printer 20 through the control pipe 41 (step S14).

The printer 20 which has received this print request transmits a command (resource file request command) to read resource files necessary for printing requested by the print request from the memory 11 of the digital camera 10 to the digital camera 10 (step S15). In response to this command, the printer 20 reads the necessary resource files from the memory 11 of the digital camera 10 through the intermediation of the device controller 17 of the digital camera 10 (step S16), and executes a print operation based on the resource files.

Here, the resource files necessary for printing includes the image data file to be printed (its path name and file name are described in the print request), the print setting file of the print setting data in which setting is described in various setting items on printing (its path name and file name are described in the print request), and so on. The printer 20 reads these resource files from the memory 11 of the digital camera 10 at its own discretion and performs conversion processes such as expansion, color conversion, and halftoning, and hence the digital camera 10 need not specially perform any complicated process.

Incidentally, in this embodiment, it is explained that these image data file and print setting data file are stored in the memory 11 of the digital camera 10 and read from the memory 11 by the printer 20, and also in this case, the image data file and the print setting data file are transmitted from the digital camera 10 through the USB connection interface cable 30 and received by the printer 20. Hence, in a broad sense, it can be said that these image data file and print setting data file are transmitted from the digital camera 10 to the printer 20.

Also during printing, the printer 20 transmits the “Interrupt In” command to the digital camera 10 at the predetermined time intervals (step S17 and so on). After the print request has been transmitted (after step S14), the digital camera 10 which has received the “Interrupt In” command transmits a printer status request to the printer 20 (step S18 and so on). The printer 20 which has received this printer status request during printing not only transmits the printer status to the digital camera 10 (step S19) but also checks up on the latest print state (for example, the number of as-yet-unprinted sheets or the number of printed sheets) and transmits a message that the printer is printing, containing data on the latest print state (step S20).

Also after the completion of printing, the printer 20 transmits the “Interrupt In” command to the digital camera 10 at the predetermined time intervals (step S21). When the printer 20 has received the printer status request from the digital camera 10 after the completion of printing (step S22), the printer 20 not only transmits the printer status (step S23) but also transmits a message that printing has been completed to the digital camera 10 through the control pipe 41 (step S24). The digital camera 10 which has received the message that the printing has been completed controls the operation of the digital camera 10 itself so that a new print request can be issued.

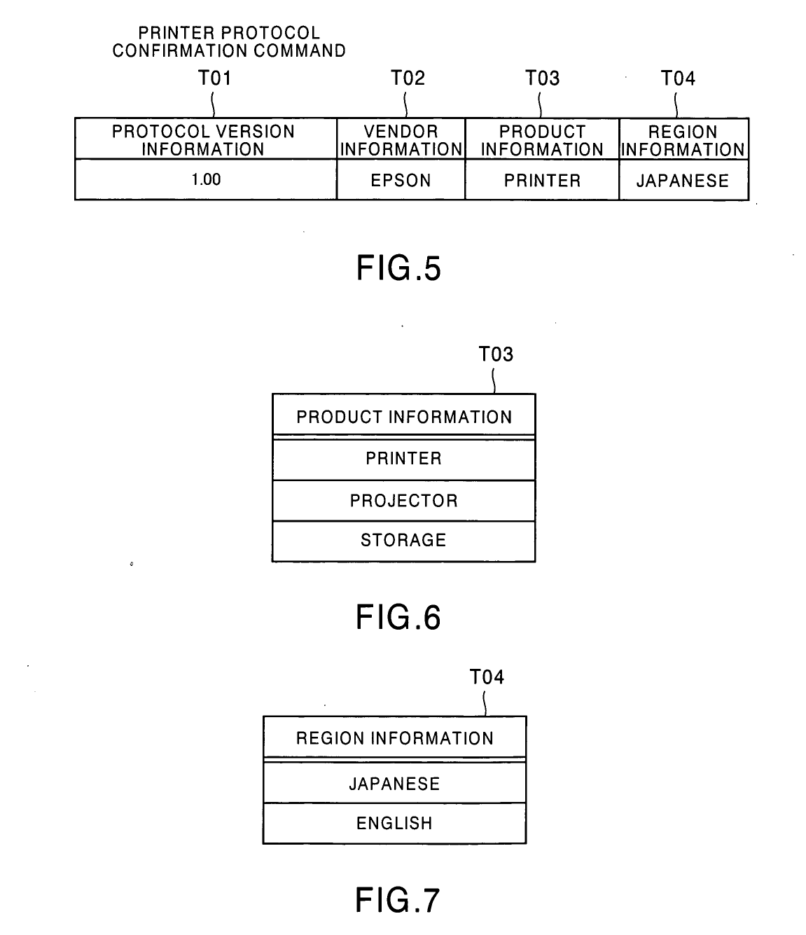

Next, the contents of the printer protocol confirmation command transmitted from the printer 20 to the digital camera. 10 in the aforementioned FIG. 3 (step S4) will be explained based on FIG. 5. FIG. 5 is a diagram showing a format of the printer protocol confirmation command. As shown in FIG. 5, the printer protocol confirmation command according to this embodiment includes protocol version information T01, vendor information T02, product information T03, and region information T04 as items.

In the protocol version information T01, information on the version of a protocol held by the printer 20 is stored. The printer 20 and the digital camera 15 communicate with each other hereafter based on this protocol version. In the example in FIG. 5, “1.00” is stored in the version information.

In the vendor information T02, information specifying a vendor which manufactures the printer 20 is stored. In the example in FIG. 5, “Epson” is stored as the vendor information. In the product information T03, information indicating the kind of the product is stored. In the example in FIG. 5, “printer” is stored as the product information. FIG. 6 shows a list of information stored in the product information T03 in this embodiment. As shown in FIG. 6, in this embodiment, any one of “printer”, “projector”, and “storage” is stored as the product information T03.

In the region information T04 in FIG. 5, information specifying the language of a region where the printer 20 is used is stored. In the example in FIG. 5, “Japanese” is stored. FIG. 7 shows a list of information stored in the region information T04 in this embodiment. As shown in FIG. 7, in this embodiment, either “Japanese” or “English” is stored as the region information T04.

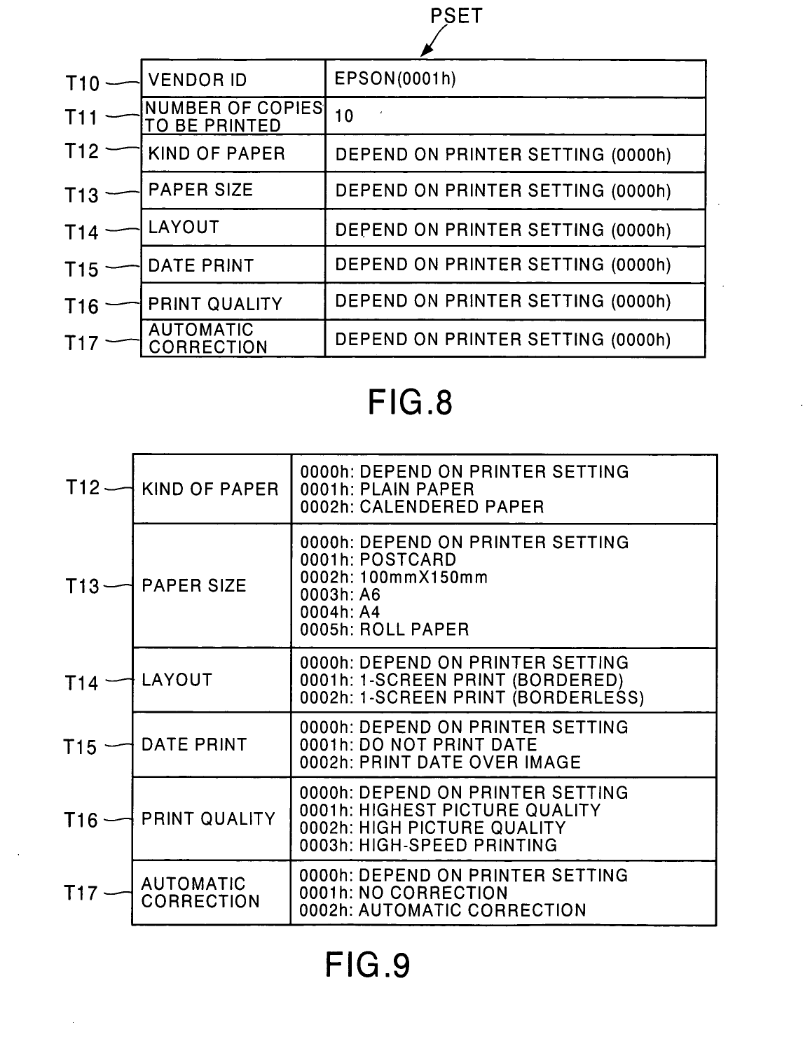

Next, the file structure and setting items of the print setting data stored in the memory 11 of the digital camera 10 according to this embodiment will be explained based on FIG. 8 and FIG. 9. FIG. 8 is a diagram showing an example of the structure of a print setting data file PSET stored in the memory 11 of the digital camera 10, and FIG. 9 is a diagram showing a list of options of setting items prescribed in the print setting data file PSET. FIG. 8 and FIG. 9 show the setting contents of the digital camera 10 when the printer protocol confirmation command shown in FIG. 5 has been received.

As shown in FIG. 8, the print setting data file PSET according to this embodiment includes a vendor ID T10, a number of copies to be printed T11, a kind of paper T12, a paper size T13, a layout T14, data print T15, a print quality T16, and an automatic correction T17 as setting items.

In the vendor ID T10, information to specify the vendor of the printer is stored. Namely, the contents of the vendor information T02 of the printer protocol confirmation command are stored.

In the number of copies to be printed T11, information for setting the number of copies of the image data to be printed, which is transmitted to the printer 20 together with the print setting data file PSET, (for example, two copies per image are printed) is stored. In the kind of paper T12, information specifying the kind of print paper on which the image data is printed is stored. As shown in FIG. 9, in this embodiment, three options of “Depend on printer setting”, “plain paper”, and “calendered paper” are provided as options of the kind of paper T12. When “Depend on printer setting” is stored in the kind of paper T12, the printer 20 performs conversion processes such as expansion, color conversion, and halftoning for the image data based on the designation of the kind of paper set at this point in time in the printer 20 instead of the designation thereof from the digital camera 10 and executes a print operation. When “plain paper” or “calendered paper” is stored in the kind of paper T12 and designated, priority is given to the designation from the digital camera 10.

In the paper size T13, information specifying the size of print paper on which the image file is printed is stored. In FIG. 9, six options of “Depend on printer setting”, “post card”, “100 mm×150 mm, “A6”, “A4”, and “roll paper” are provided as options of the paper size T13. When “Depend on printer setting” is stored in the paper size T13, the printer 20 executes a print operation based on the designation of a paper size set at this point in time in the printer 20 instead of the designation thereof from the digital camera 10. Namely, the printer 20 performs conversion processes such as expansion, color conversion, and halftoning for the image data to fit the paper size set in the printer and executes a print operation. On the other hand, “post card”, “100 mm×150 mm”, “A6”, “A4”, or “roll paper” is stored in the paper size T13, priority is given to the designation from the digital camera 10. For example, when “postcard” is designated as the paper size T13, the printer 20 performs conversion processes such as expansion, color conversion, and halftoning for the image data to fit the postcard size and executes a print operation.

Moreover, the vendor information T02 is “Epson” in this embodiment, and hence “roll paper” is added to the options of the paper size T13. Namely, some vendors may not provide support for roll paper. Accordingly, the digital camera 10 in this embodiment is not provided with “roll paper” as an option of the paper size T13 in a default case. However, when the printer 20 to which the digital camera 10 is connected is manufactured by a vendor which provides support for roll paper, “roll paper” is added to options.

In the layout T14, information specifying a layout when the image data file is printed. In this embodiment, three options of “Depend on printer setting”, “1-screen print (bordered)”, and “1-screen print (borderless) ” are provided as options of the layout T14. when “Depend on printer setting” is stored in the layout T14, the printer 20 executes a print operation based on the designation of a layout set at this point in time in the printer 20 instead of the designation thereof from the digital camera 10. Namely, the printer 20 performs conversion processes such as expansion, color conversion, and halftoning for the image data to fit the layout set in the printer and executes the print operation. “1-screen print (bordered)” is stored in the layout T14, based on this designation, the printer 20 performs conversion processes such as expansion, color conversion, and halftoning for the image data in the layout in which one image is printed on one piece of print paper and so as to fit the bordered layout, and executes a print operation. When “1-screen print (borderless)” is stored in the layout T14, based on this designation, the printer 20 performs conversion processes such as expansion, color conversion, and halftoning for the image data in the layout in which one image is printed on one piece of print paper and so as to fit the borderless layout, and executes a print operation.

In the date print T15, information specifying whether the picture taking date is printed when the image data file is printed is stored. In this embodiment, three options of “Depend on printer setting”, “Do not print date”, and “Print date over image” are provided as options of the date print T15. When “Depend on printer setting” is stored in the date print T15, the printer 20 executes a print operation based on the designation of the presence/absence of date print which is set at this point in time in the printer 20 instead of the designation thereof from the digital camera 10. Namely, the printer 20 performs conversion processes such as expansion, color conversion, and halftoning for the image data so as to fit the setting of the presence/absence of date print registered with the printer and executes the print operation. When “Do not print date” is stored in the date print T15, based on this designation, the printer 20 performs conversion processes such as expansion, color conversion, and halftoning for the image so as not to print the picture taking date, and executes a print operation. When “Print date over image” is stored in the date print T15, based on this designation, the printer 20 performs conversion processes such as expansion, color conversion, and halftoning for the image data, for example, so as to print the picture taking date in the right corner of the image to be printed over the image, and executes a print operation.

In the print quality T16, information specifying the quality when the image file is printed is stored. In this embodiment, four options of “Depend on printer setting”, “highest picture quality”, “high picture quality”, and “high-speed printing” are provided as options of the print quality T16. When “Depend on printer setting” is stored in the print quality T16, the printer 20 executes a print operation based on a print quality set at this point in time in the printer 20 instead of the designation thereof from the digital camera 10. Namely, the printer 20 performs conversion processes such as expansion, color conversion, and halftoning for the image data so as to fit the print quality set in the printer and executes the print operation. When “highest picture quality”, “high picture quality”, or “high-speed printing” is stored in the print quality T16, the printer 20 performs conversion processes such as expansion, color conversion, and halftoning for the image data so as to fit the quality based on this designation, and executes a print operation.

In the automatic correction T17, information specifying whether automatic correction is performed when the image file is printed is stored. In this embodiment, three options of “Depend on printer setting”, “no correction”, and “automatic correction” are stored as options of the automatic correction T17. When “Depend on printer setting” is stored in the automatic correction T17, the printer 20 executes a print operation based on the presence/absence of automatic correction set at this point in time in the printer 20 instead of the designation thereof from the digital camera 10. Namely, the printer 20 performs conversion processes such as expansion, color conversion, and halftoning for the image data to fit the setting of the presence/absence of automatic correction registered with the printer and executes the print operation. When “no correction” is stored in the automatic correction T17, the printer 20 performs conversion processes such as expansion, color conversion, and halftoning for the image so as to print the image without automatic correction, and executes a print operation. When “automatic correction” is stored in the automatic correction T17, the printer 20 performs conversion processes such as expansion, color conversion, and halftoning for the image data, for example, so as to adjust the brightness of the image to be printed, and executes a print operation.

As can be seen from the above description, the printer 20 judges whether each setting item of the received print setting data is “dependent setting” which indicates dependence on printer setting or “independent setting” which indicates dependence on setting designated in the print setting data. As concerns setting items being dependent setting, conversion processes such as expansion, color conversion, and halftoning for the image data are performed based on print setting registered with the printer at that point in time, and as concerns setting items being independent setting, conversion processes such as expansion, color conversion, and halftoning for the image data are performed based on setting designated in the print setting data.

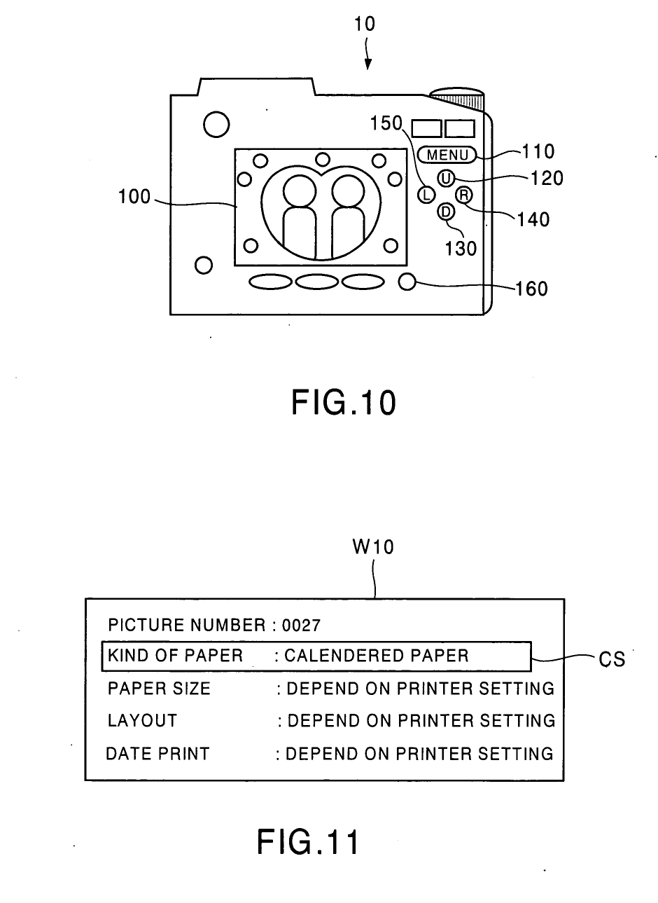

Next, operations when the user performs print setting by the use of the digital camera 10 will be explained based on FIG. 10 and FIG. 11. FIG. 10 is a diagram showing an example of a layout on the operation surface side of the digital camera 10, and FIG. 11 is a diagram showing an example of a print setting screen W10.

As shown in FIG. 10, the digital camera 10 according to this embodiment is provided with a liquid crystal display panel 100 in its central portion. When the user takes a picture with this digital camera 10, an image to be taken is displayed on the liquid crystal display panel 100.

On the right side of the liquid crystal display panel 100, a menu button 110, an upward button 120, a downward button 130, a rightward button 140, a leftward button 150, and a decision button 160 are arranged. When the user presses the menu button 110 to select a printer setting screen, the printer setting screen W10 shown in FIG. 11 is displayed.

As shown in FIG. 11, a cursor CS is displayed on the print setting screen W10. This cursor CS moves upward by pressing the upward button 120, and moves downward by pressing the downward button 130. Moreover, by pressing the rightward button 140, options of the setting item at which the cursor CS is located are shifted in a forward direction, and by pressing the leftward button 150, the options are shifted in a backward direction. For example, if the rightward button 140 is pressed while the cursor CS is located in the kind of paper, “Depend on printer setting”, “plain paper”, and “calendered paper” are displayed as options in sequence.

If the downward button 130 is pressed while the cursor CS is located at the setting item on the lowest side of the print setting screen W10, the print setting screen W10 scrolls down in sequence, and the next setting items are displayed. Contrary to this, if the upward button 120 is pressed while the cursor CS is located at the setting item on the uppermost side of the print setting screen W10, the print setting screen W10 scrolls up in sequence, and the previous setting items are displayed.

The image to be printed is selected by moving the cursor CS to the position of “picture number” and operating the rightward button 140 and the leftward button 150. Namely, by pressing the rightward button 140, the picture number increases by one, and by pressing the leftward button 150, the picture number decreases by one. The user performs the selection of the picture to be printed and print setting thereof by repeating the above operation.

When all settings are completed, the user presses the decision button 160 shown in FIG. 10. By pressing the decision button 160, one image data file held in the memory 11 is specified, and a print setting data file based on the set contents is formed in the memory 11. Then, the aforementioned print request command (See step S14 in FIG. 4) is transmitted from the digital camera 10 to the printer 20, and a print operation is started. Namely, the image data file and the print setting data file are transmitted to the printer 20, and the print operation is started.

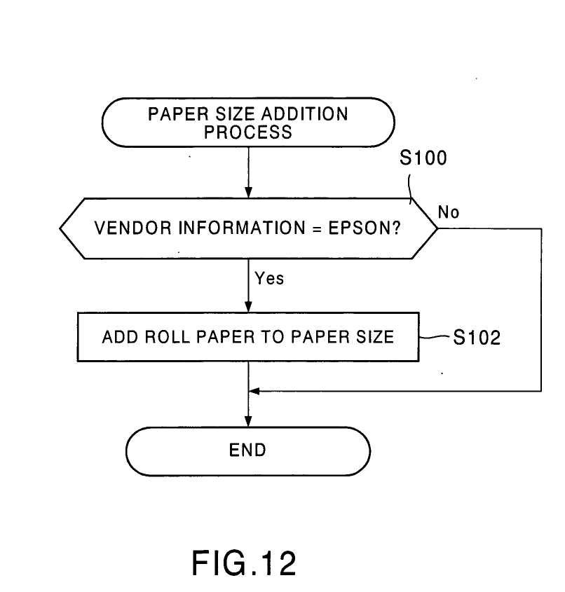

Next, a paper size addition process executed when the digital camera 10 according to this embodiment has received the printer protocol confirmation command will be explained based on FIG. 12. FIG. 12 is a flowchart explaining the paper size addition process executed by the camera controller 15 of the digital camera 10 when the digital camera 10 according to this embodiment has received the printer protocol confirmation command.

As shown in FIG. 12, when the digital camera 10 has received the printer protocol confirmation command, the digital camera 10 judges whether the vendor information T02 contained in the received printer protocol confirmation command is “Epson” (step S100).

When the vendor information T02 is “Epson” (step S100: Yes), a process of adding “roll paper” to options of the paper size T13 (step S102) is executed. On the other hand, when the vendor information T02 is not “Epson” (step S100: No), the process in step S102 is not executed.

Thus, the paper size addition process is completed, and when the printer 20 is an Epson printer, “roll paper” is added to options of the paper size T13.

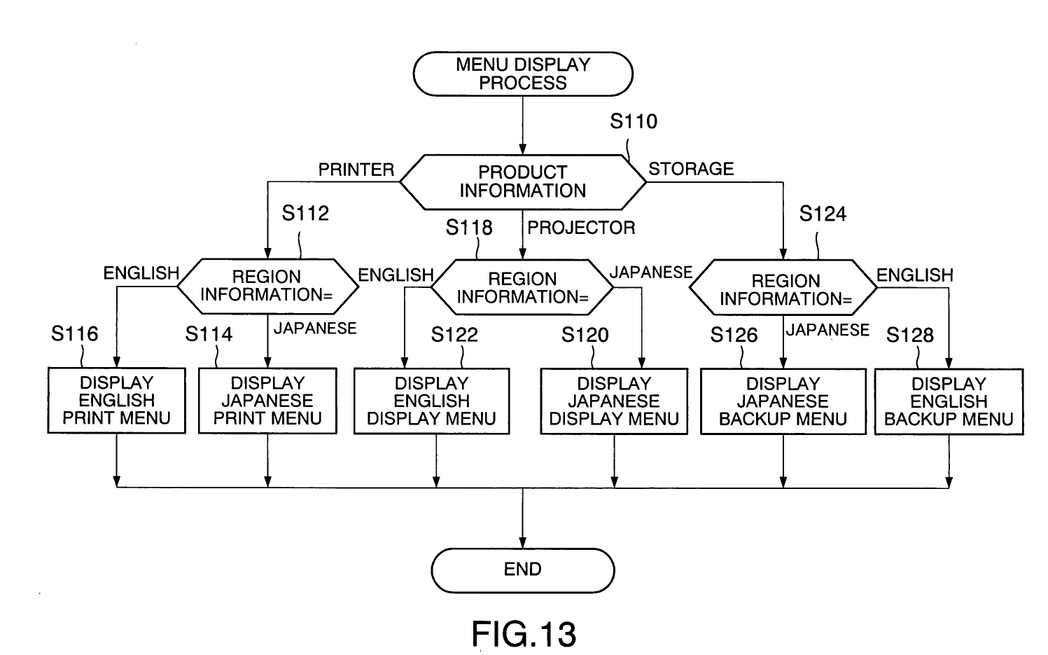

Next, a menu display process executed when the user presses the menu button 110 (See FIG. 10) will be explained based on FIG. 13. FIG. 13 is a flowchart explaining the contents of the menu display process executed by the controller 15 when the user presses the menu button 110.

As shown in FIG. 13, when the menu button 110 is pressed, the digital camera 10 judges whether the product information T03 contained in the printer protocol confirmation command received in step S4 in FIG. 3 is “printer”, “projector”, or “storage” (step S110).

When the product information T03 is “printer”, the digital camera 10 judges whether the region information T04 contained in the printer protocol confirmation command is “Japanese” or “English” (step S112). When the region information T04 is “Japanese”, a Japanese print menu is displayed on the liquid crystal display panel 100 (step S114). The contents of this Japanese print menu are, for example, as shown in FIG. 11.

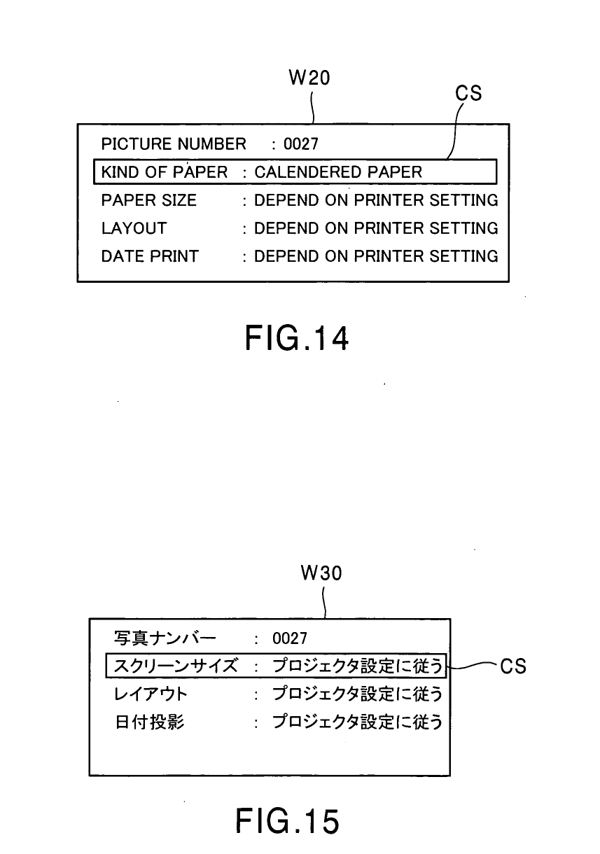

On the other hand, when the region information T04 is “English”, an English print menu is displayed on the liquid crystal display panel 100 (step S116). This English print menu is, for example, a display on a print setting screen W20 such as shown in FIG. 14.

When it is judged in the aforementioned step S110 that the product information T03 is “projector”, the digital camera 10 judges whether the region information T04 contained in the printer protocol confirmation command is “Japanese” or “English” (step S118). When the region information T04 is “Japanese”, a Japanese display menu is displayed on the liquid crystal display panel 100 (step S120). This Japanese display menu is, for example, a display on a display setting screen W30 as shown in FIG. 15.

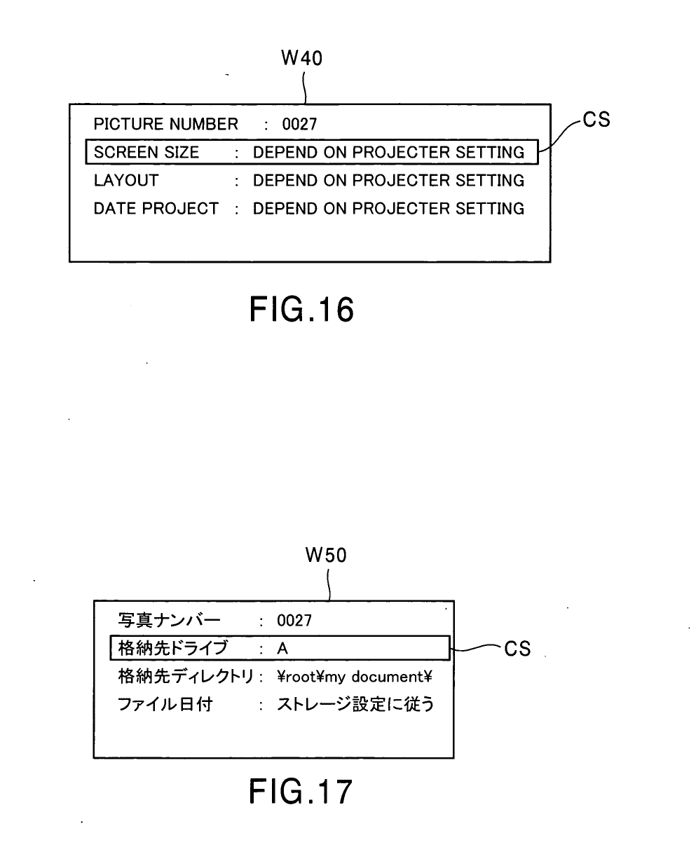

On the other hand, when the region information T04 is “English”, an English display menu is displayed on the liquid crystal display panel 100 (step S122). This English display menu is, for example, a display on a display setting screen W40 such as shown in FIG. 16.

When it is judged in the aforementioned step S110 that the product information T03 is storage”, the digital camera 10 judges whether the region information T04 contained in the printer protocol confirmation command is “Japanese” or “English” (step S124). When the region information T04 is “Japanese”, a Japanese backup menu is displayed on the liquid crystal display panel 100 (step S126). This Japanese backup menu is, for example, a display on a backup setting screen W50 as shown in FIG. 17.

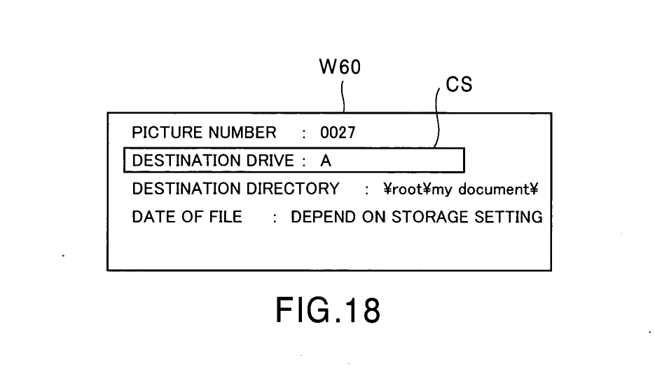

On the other hand, when the region information T04 is “English”, an English backup menu is displayed on the liquid crystal display panel 100 (step S128). This English backup menu is, for example, a display on a display setting screen W60 such as shown in FIG. 18.

As stated above, according to the print system of this embodiment, the menu displayed in the digital camera 10 is changed according to the kind of a product to which the digital camera 10 is connected, and hence the menu which causes no uncomfortable feeling to the user who performs a menu operation can be displayed. For example, the print setting screen W10 such as shown in FIG. 11 is displayed when the digital camera 10 is connected to “printer”, and the display setting screen W30 such as shown in FIG. 15 is displayed when the digital camera 10 is connected to “projector”. Therefore, a menu screen fitting the product of an image data receiving device can be automatically displayed without the user being aware of the kind of the image data receiving device to which the digital camera 10 is connected.

Moreover, the language used in the menu is changed automatically based on the region information held by the printer 20, so that the menu can be displayed on the screen automatically with the language which suits each nation without the user specially inputting and designating the language to be used.

Further, it is determined whether the roll paper is added to the paper size to be used based on the vendor information on the printer 20 to which the digital camera 10 is connected, which can avoid the roll paper from being displayed as an option on the print setting screen W10 of the vendor which does not provide support for the roll paper.

Furthermore, according to the print system of this embodiment, the option of “Depend on printer setting” is provided in setting items of print setting, so that the user can print the image in the digital camera 10 based on the print setting set by operating the control panel 27 on the printer 20 side. Consequently, user-friendliness increases. For example, if the paper size is set to “postcard” on the printer 20 side, and the paper size T13 is set to “Depend on printer setting” in the digital camera 10, on the printer 20 side, image data can be subjected to expansion, color conversion, and halftoning in the size which fits postcard size printing on the premise that the size of print paper for printing is a postcard size.

Besides, if setting items in print setting are each provided with an option which is entrusted to the designation on the printer 20 side, a manufacturer of the digital camera 10 need not design the print setting screen W10 according to many printer models. Namely, in many cases, options of setting items in print setting differ depending on printer models. Therefore, if necessary setting items in print setting are always designated from the digital camera 10 side, the manufacturer of the digital camera 10 is required to design the print setting screen W10 for each printer model. However, if at least the option of “Depend on printer setting” is provided as in this embodiment, it is not always necessary to design the print setting screen W10 for each printer model.

If further reference is made, the digital camera 10 side is only required to include a function of selecting image data to be printed if all of print setting items depend on printer setting, whereby the design concerning the print setting of the digital camera 10 can be extremely simplified. In this case, the user does not set the setting items of print setting, but the digital camera 10 holds the value of “Depend on printer setting” as a setting value, and transmits this value with image data to the printer 20 regardless of the user's intention.

It should be mentioned~that the present invention is not limited to the aforementioned embodiment, and various changes may be made therein. For example, in the aforementioned embodiment, the digital camera 10 and the printer 20 are connected by USB communication, but they may be connected by some other communication standard such as parallel communication.

Moreover, setting items of print setting data are not limited to the setting items in the aforementioned embodiment, and other setting items maybe contained or the setting items given as examples in the embodiment may be omitted. Further, the kind and number of options thereof can be freely designed. Furthermore, the explanation of the process of adding an option is given with the roll paper of the paper size T13, but a different option of some other item may be added.

Besides, in the aforementioned embodiment, the vendor information T02, the product information T03, and the region information T04 are given as examples of device information on the printer 20, but some other information may be used as device information.

In addition, in the aforementioned embodiment, the digital camera 10 is given as an example of an image data transmitting device, and the printer 20, the projector, or the backup storage is given as an example of an image data receiving device, but a combination of the image data transmitting device and the image data receiving device is not limited to the above. In this case, setting items contained in a setting screen may be designed properly according to the kinds of the image data transmitting device and the image data receiving device.

What is claimed is:

1. A control method of an image data transmitting device connected to an image data receiving device, comprising the steps of:
acquiring device information on the image data receiving device from the image data receiving device to which the image data transmitting device is connected;
selecting contents of setting on image data of the image data receiving device when the image data is transmitted to the image data receiving device based on the acquired device information; and
displaying the selected contents of setting.

2. The control method of the image data transmitting device according to claim 1, wherein the step of selecting the contents of setting comprises the step of selecting the contents of setting based on vendor information on the image data receiving device.

3. The control method of the image data transmitting device according to claim 1, wherein the step of selecting the contents of setting comprises the step of selecting the contents of setting based on product information specifying a kind of the image data receiving device.

4. The control method of the image data transmitting device according to claim 1, wherein the step of selecting the contents of setting comprises the step of adding an option of the contents of setting if the acquired device information is predetermined information.

5. The control method of the image data transmitting device according to claim 1, wherein the step of selecting the contents of setting comprises the step of selecting the contents of setting based on region information specifying a region where the image data receiving device is used.

6. The control method of the image data transmitting device according to claim 5, wherein the step of displaying the contents of setting comprises the step of selecting a language when the contents of setting are displayed based on the region information.

7. An image data transmitting device connected to an image data receiving device, comprising:
a device information acquisition which acquires device information on the image data receiving device from the image data receiving device to which the image data transmitting device is connected;
a setting displayer which displays setting on image data of the imaged at a receiving device when the image data is transmitted to the image data receiving device; and
a display selector which selects contents of the setting displayed on the setting displayer based on the device information acquired by the device information acquisition.

8. An image data transmitting and receiving system including an image data receiving device and an image data transmitting device connected to the image data receiving device, wherein
the image data transmitting device comprises:
a device information acquisition which acquires device information on the image data receiving device from the image data receiving device to which the image data transmitting device is connected;
a setting displayer which displays setting on image data of the image data receiving device when the image data is transmitted to the image data receiving device;
a display selector which selects contents of the setting displayed on the setting displayer based on the device information acquired by the device information acquisition; and
a transmitter which transmits setting information set by a user based on the display selector and the image data to the image data receiving device, and
the image data receiving device comprises:
a receiver which receives the setting information and the image data; and
an image data processor which processes the image data based on the setting information.
